(19) United States
(12) Patent Application Publication
(10) Pub. No.: US 2004/0248716 A1
(43) Pub. Date: Dec. 9, 2004

(54) Method for applying a flocking material to a foamable and sleeve shaped roller as well flock applied roller article used in applying a wallpaper adhesive or a gel removal fluid

(76) Inventor: Linda Mitchell, Nashville, TN (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/457,754

(22) Filed: Jun. 9, 2003

(51) Int. Cl. B25F 5/02

(52) U.S. Cl. 492/13; 29/895.21

(57) ABSTRACT

A roller for use with an applicator device in the application of a viscous fluid onto a wall or wallpaper surface. The device includes a handle and an arcuately configured and extending neck which terminates in an elongate extending support. The roller includes a substantially sleeve shaped body having an outwardly facing surface and an inwardly facing surface dimensioned to be slidably engaged over the rotatable support. An outwardly facing surface of the sleeve shaped body further exhibits a suitable, such as a foamable, configuration. A plurality of synthetic fibers are applied, such as by a suitable flocking process, upon the outwardly facing surface of the sleeve shaped body and permits a desired volume of the fluid to be absorbed into a foam sleeve for subsequent and even application over a selected surface area of the surface.

### BACKGROUND OF THE INVENTION

1. Field of the Invention

The present invention relates generally to roller applicator devices. More particularly, the present invention teaches a generally cylindrical and sleeve shaped roller applicator and method of construction, and by which a quantity of precision cut synthetic fibers are applied by a suitable flocking process upon a foamed substrate material. The present invention is further an improvement over prior art foam and cloth applicators, in that it provides increased viscous fluid retention and application characteristics, particularly in use with thicker fluidic adhesives and such as are typically applied prior to the layering of a wallpaper or like wall covering material or gel removers which are applied to remove a previously applied wall covering.

2. Description of the Prior Art

Paint roller devices are fairly well known in the art. The most common type of roller is the foam roller having a specified length, diameter and foam nap. The dimensions of the foam nap typically range in the area of ⅜″.

It has been found that the typical foam roller, while generally being capable of adequately absorbing and reapplying volumes of paints, stains and varnishes, is poorly adapted for use in absorbing and reapplying volumes of viscous based wallpaper adhesive or gel removers, largely due to its fine and relatively small density foam material construction as well as the fact that only a thin layering of foam material is present on the roller. An additional problem with such foam material being utilized to absorb and reapply such adhesive further results from the greater density and weight associated with such fluid based adhesives and the fact that the conventional foam roller (typically thin layered) is very limited in the porous holding capability as a result of its given nap configuration. As such, the fluid adhesive tends to adhere only to the top surface of the foam roller and is substantially transferred onto the wall surface in the course of the initial swipe or stroke of the roller, thus greatly reducing the ability to thickly and evenly apply the adhesive or gel remover on the wall surface.

It has been found that rollers utilizing a given cloth nap design will in fact permit only a small amount of paste to absorb into the nap. However, much the same result as with the foam roller is achieved upon application and with substantially all the fluid adhesive/gel remover being transferred on the initial swipe across the wall surface and redistributed in succeeding strokes, thus resulting in generally thin and uneven applications. This further causes the applied adhesive to dry quickly, making the application of the wall covering (wallpaper, border, etc.) more difficult. It is additionally known to apply adhesives using a hand brush and, while being generally capable of absorbing and applying a minimal volume of fluid adhesive, the brush suffers from many of the shortcomings of foam and cloth nap rollers in that much of the retained adhesive is released/reapplied.

Additional examples of wall covering apparatuses are known in the prior art and a first example of which is referenced in U.S. Pat. No. 4,834,237, issued to Henke, et al. which teaches the provision of a wall covering kit having a tray, cover, and plurality of tool storage compartments. Among the tool implements used with the tray kit are a standard nap roller (with cage frame) and a substantially planar and rectangular shaped sponge (see illustrated in broken lines at 33 in Henke). Henke does not however teach or suggest the incorporation of a sponge mat or nap design into the roller implement, nor any inspiration for doing the same, including the desire to evenly and completely apply a fluid adhesive or the like.

Also, U.S. Pat. No. 5,837,084, issued to Barss, teaches an improved method of making a single-cell structure including the formation of a double-cell honeycomb fabric structure from a single continuous length of foldable material and which further removes parts of the cells defining a face of the double honeycomb structure in order to obtain a desired single-cell structure having folded outwardly extending pleats on one face and tabbed outwardly extending pleats on the other face. Barrs does not teach or suggest the application of such technology to the formation of an adhesive sponge roller with flock fiber nap or gel removal roller or like applicator.

### SUMMARY OF THE PRESENT INVENTION

The present invention teaches a generally cylindrical and sleeve shaped roller applicator and method of construction, and by which a quantity of precision cut synthetic fibers are applied by a suitable flocking process upon a foamed substrate material of a sponge nap material. The fiber flocked roller applicator of the present invention is further an improvement over prior art paste applicators, such as again including paste brushes, foam paint rollers, and textile paint rollers, in that it provides for more consistent (accurate and thicker amount) and even distribution of the wallpaper paste material as well as the redistribution of the material, particularly in use with such as thicker fluidic adhesives and such as are typically applied prior to the layering of a wallpaper or like wall covering material and which are reapplied and redistributed in succeeding strokes. Also, a wallpaper gel remover is applied in the same fashion and in order to loosen up an existing wall covering.

In the preferred variant, the roller applicator includes a substantially sleeve shaped and conventional foam material having an outwardly facing surface and an inwardly facing surface dimensioned to be slidably engaged over a rotatable support associated with the application device, such as further may be a roller. In particular, and as is also known in the art, a hollow core element constructed of a moisture and solvent material may be employed as an intermediary between the inwardly facing surface of the body and the rotatably associated support of the applicator device, such including a plurality of spaced apart and parallel extending wire frame elements in one variant. A suitable applicator device may also consist of a plasticized and elongated tube inserted into the roller and which has a rotating clamp element in order to secure to an existing frame element.

Applied to the exterior or outwardly facing surface of the foam sleeve body is a plurality of precision cut synthetic fibers, such as including nylon, polyester, rayon or acrylic materials. The fibers are typically applied by a “flocking” process and by which they are adhered to a pre-applied adhesive coated upon the exterior surface of the foam sleeve. The flocking process may further include both mechanical processes in which the synthetic fibers are applied to the adhesively coated surface of the foam roller, as well as electrostatic processes by which the fibers are magnetically attracted to the desired coating surface through the creation of an electrical field.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a view of a substantially sleeve shaped and flocked roller according to a first preferred embodiment of the present invention;

FIG. 2 is a side view of a further variation of sleeve shaped and flocked roller exhibiting a different handle configuration and according to the present invention;

FIG. 3 is a first end view of a foam roller illustrating a plurality of flocked fibers applied thereupon and according to the present invention;

FIG. 4 is a second end view of a foam roller and illustrating a further plurality of flocked fibers applied thereupon according to the present invention;

FIG. 5 is an illustration of an electrostatic application process and by which the fibers are flocked upon the foam sleeves according to the present invention;

FIG. 6 is a perspective illustration of a foam roller and illustrating the pre-application of adhesive upon its exterior facing surface; and

FIG. 7 is an illustration of a mechanical application process and by which the fibers are again applied upon the exterior facing surface of the foam sleeves.

### DETAILED DESCRIPTION OF THE PREFERRED EMBODIMENTS

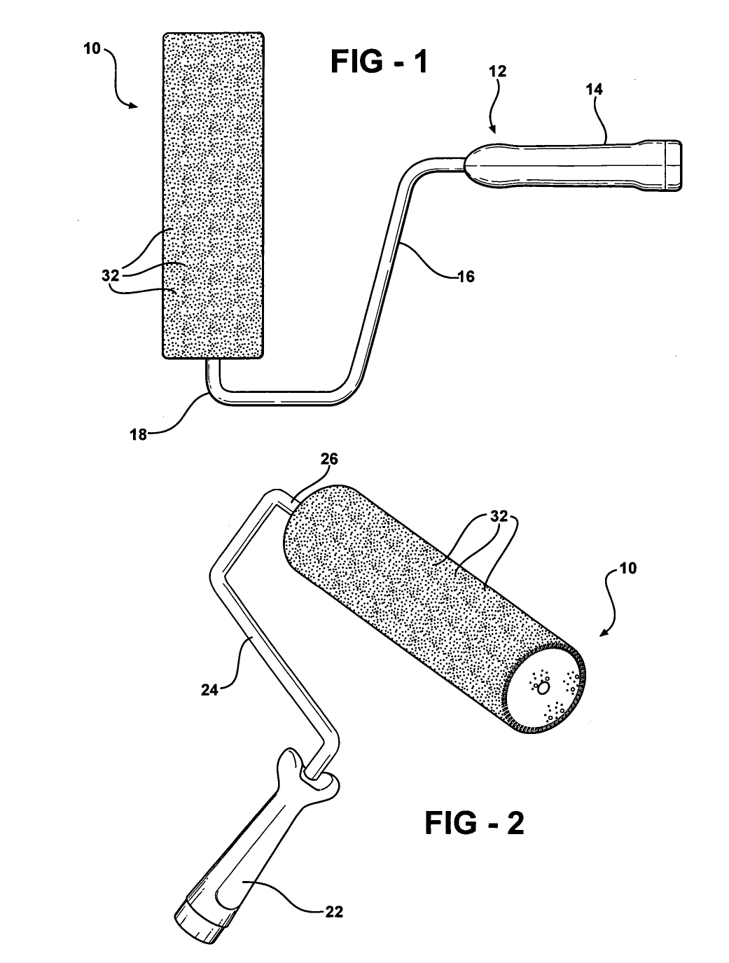

Referring now to FIG. 1, the substantially sleeve shaped and flocked roller is illustrated at 10 according to a first preferred embodiment of the present invention. As previously described, the present invention is an improvement over prior art foam and cloth nap roller applicators, as well as hand-held brush applicators, in that the synthetic cut fibers applied to the roller provide appropriate flow of the fluid material applied, the foam pores providing increased viscous fluid retention and even application characteristics, particularly in use with thicker fluidic adhesives (as well as gel wallpaper removers) and such as are typically applied prior to the layering of a wallpaper or like wall covering material or reapplication/redistribution over succeeding strokes, as well as after a previously applied wall covering in the instance of a gel remover.

Referring again to FIG. 1, the roller 10 is again illustrated in combination with an applicator device, generally represented at 12, and for use in the application of the viscous fluid (not shown) onto a wall surface. The applicator device is by itself relatively known in the art and includes such features as a handle 14, an arcuately configured and extending neck 16 and support 18.

Referring to FIG. 1, opposite end 19 may be designed to cut into corners of a wall surface, as well as roll along an edge of a wall covering and in order to quickly coat the edges thereof.

Referring again to the alternate configuration of FIG. 2, another variation of a rotatable support 20 is illustrated in use with the roller 10 and again includes a handle 22, arcuately configured and extending neck 24, and extending support 26. Although not further shown, in either FIGS. 1 and 2, the rotatable supports 18 and 26 may, as is conventionally known, further include a plurality (such as five) of spaced apart and parallel extending wire frame elements and over which the roller 10 is applied, typically in a friction fitting manner. Although not also shown, it is also understood that an elongated pole or other suitable attachment may be engaged (typically in threaded fashion) with a selected insertion end of the handle configurations and as is well known in the art. As has again been previously stated, the applicator device may also consist of a plasticized and elongated tube inserted into the roller and which has a rotating clamp element in order to secure to an existing frame element.

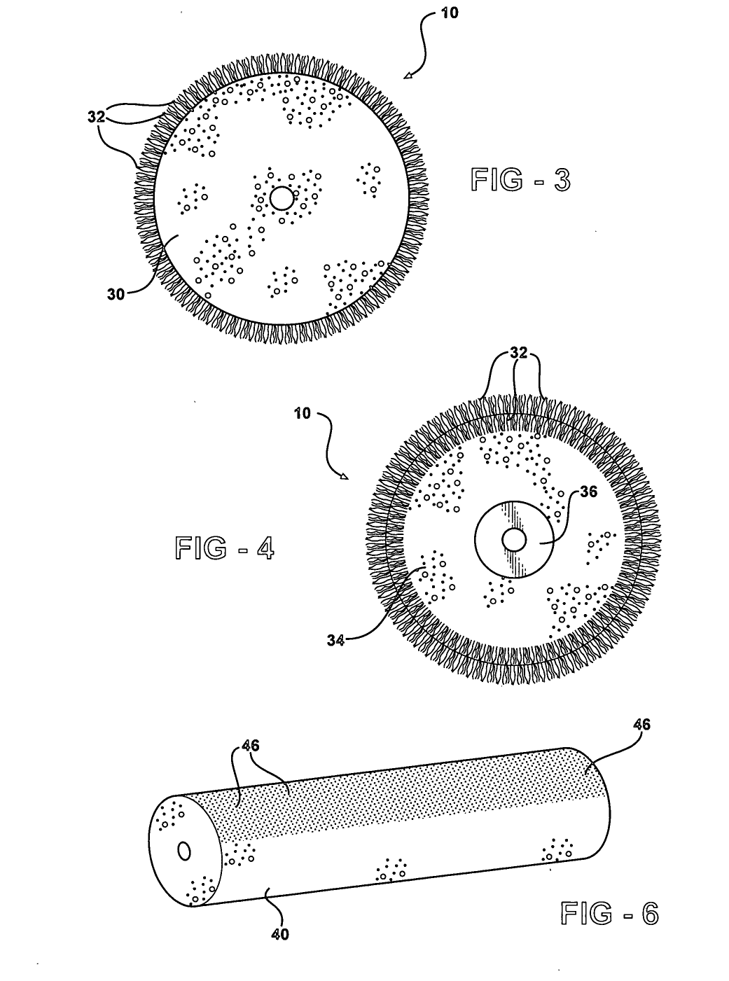

Referring now to FIG. 3, an end view is illustrated of a foam roller 10, see in particular first circular end 30, and upon which a plurality of flocked fibers 32 are applied (according to either the mechanical or electrostatic methods to be subsequently described) and according to the present invention. The ability to apply a plurality of synthetic cut fibers, such as again including those drawn from such materials as nylon, polyester, acrylic and rayon, enables the flocked fibers 32 on the roller 10 to redistribute the desired fluidic material previously absorbed by the foam pores more evenly and to a greater degree.

Referring to FIG. 4, a second end view of the foam roller 10 is exhibited and which illustrates a further plurality of flocked fibers 32 applied thereupon. The end view of FIG. 4, illustrating a second circular end 34, also includes a narrowed central aperture which is defined by an annular core 36 and facilitates the insertion of a suitable and narrow rotatable support element. It has also been determined that the small diameter tube insert, for holding wire frame elements (not shown) allows for a desired increase in the thickness or depth of the foam versus standard 2 inch diameter cage frames. It has further been determined that a suitably constructed flock roller can hold a greater percentage of adhesive fluid or paste than that which is associated with conventional foam and textile rollers with a standard cage frame design or standard ½-¼″ nap or a standard PVC for cage frame rollers.

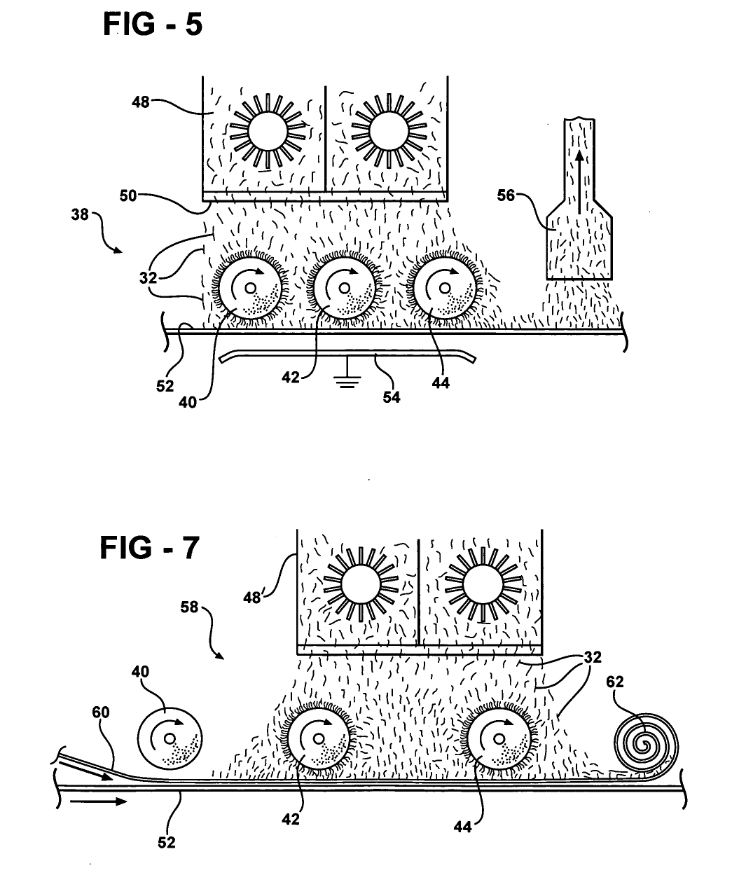

Referring now to FIG. 5, an illustration is shown generally at 38 of an electrostatic application process and by which the fibers 32 are flocked upon a plurality of foam sleeves, see at 40, 42, 44, et seq., according to one preferred application of the present invention. As is known, electrostatic flocking utilizes a field of static electricity and in order to orient the fibers and to promote a generally perpendicular alignment with respect to a coating surface of the rollers. Referencing further FIG. 6, a sample roller 40 is again illustrated and upon which is pre-applied an adhesive coating 46, this enabling the subsequent application of the flocked fibers 32.

Referring again to FIG. 5, a flock hopper is generally shown at 48 and by which the plurality of synthetic cut fibers are distributed in a generally downwardly blown manner. A positive electrode grid 50 is associated with the bottom of the hopper. The rollers 40, 42, 44, et seq., may be arranged in any desired fashion as they pass through the downwardly dispensed field of the fibers 32, but are in one variant mounted so that they are rotated in either of clockwise or counter-clockwise directions (see rotation directional arrows in FIG. 5 associated with each of the rollers).

A conveyor 52 is located, usually underneath the rollers, and by which fibers 32 adhered to the rollers are captured. A grounded electrode is illustrated at 54 and, in combination with the positive electrode grid 50 associated with the hopper, assists in creating the desired electromagnetic field for applying and adhering the fibers 32 to the rollers 40, 42, 44, et seq. In this manner the electrostatically charged fibers are evenly applied upon the foam outer surface layer of the rollers. A suction column 56, located downstream of the fiber hopper 48, removes excess flock fibers 32 not adhered to a given roller.

Referring finally to FIG. 7 is an illustration of an alternate and mechanical application process, see at 58, and by which the fibers 32 are again applied upon the exterior facing surface of the foam sleeves 40, 42, 44, et seq.

A flock hopper 48′ may again be provided and by which the flock fibers 32 are mechanically dispersed downwardly. The rollers 40, 42, 44, et seq., are again arranged either upon or spaced slightly upwardly from a conveyor 52 and so are again rotated to draw and adhere thereupon the pluralities of flocked fibers 32. It is also desirous, in one application, to provide a disposable sheet 60, in relation to the conveyor 52, and so that the unused flock fibers 32 collect thereupon and are taken up by a reel 62 after flocking of the sleeves. It is also envisioned that other and additional flocking processes can be utilized and in order to effectively apply the synthetic fibers upon the exterior surfaces of the foam sleeves or cylinders.

Having described my invention, additional preferred embodiments will become apparent to those skilled in the art to which it pertains and without deviating from the scope of the appended claims.

I claim:

1. A roller for use with an applicator device in the application of a viscous fluid onto a surface, the device including a handle and an arcuately configured and extending neck which terminates in an elongate extending support, said roller comprising:
a substantially sleeve shaped body having an outwardly facing surface and an inwardly facing surface dimensioned to be slidably engaged over the support;
said outwardly facing surface of said sleeve shaped body further exhibiting a substantially foamable consistency; and
a plurality of synthetic fibers being applied onto said outwardly facing surface of said sleeve shaped body and for distributing a desired volume of the fluid retained by said sleeve shaped body over a selected area of the surface.

2. The roller as described in claim 1, said flocking fibers each having a specified length and thickness and including at least one of a nylon, rayon, acrylic or polyester material.

3. The roller as described in claim 1, said sleeve shaped body having a specified length and outer diameter and further including a pre-applied adhesive.

4. The roller as described in claim 1, further comprising an electrostatic process for applying said plurality of synthetic fibers onto said outwardly facing surface of said sleeve shaped body.

5. The roller as described in claim 1, further comprising a mechanical and adhesive applying process for applying said plurality of synthetic fibers onto said outwardly facing surface of said sleeve shaped body.

6. The roller as described in claim 1, further comprising a hollow core element having a specified length and diameter, said inwardly facing surface of said sleeve shaped body being slidably and frictionally engaged over an exterior facing surface of said core element.

7. A method for applying a plurality of synthetic fibers upon a roller for use with an applicator device in the application of a viscous fluid onto a surface, said method comprising the steps of:
providing a substantially sleeve shaped body having an outwardly facing surface and an inwardly facing surface dimensioned to be slidably inter-engaged with a roller support; and
applying a plurality of synthetic fibers being evenly and upon said outwardly facing surface of said sleeve shaped body to permit a desired volume of the fluid to be absorbed for subsequent and even application over a selected surface area of the surface.

8. The method as described in claim 7, further comprising the step of pre-applying an adhesive coating upon said outwardly facing surface of said sleeve shaped body prior to applying said plurality of synthetic fibers.

9. The method as described in claim 7, said step of applying said plurality of synthetic fibers further comprising an electrostatic application process.

10. The method as described in claim 7, said step of applying said plurality of synthetic fibers further comprising a mechanical application process.
